(19) United States
(12) Patent Application Publication
(10) Pub. No.: US 2008/0059353 A1
(43) Pub. Date: Mar. 6, 2008

(54) System and method for retrieving and analyzing information on securities and trading securities

(75) Inventor: Thomas Carter Ronk, Corona Del Mar, CA (US)

Correspondence Address: Thomas C. Ronk, 417 Orchid Ave., Corona Del Mar, CA, 92625, US

(73) Assignee: MR. THOMAS CARTER RONK, CORONA DEL MAR, CA (US)

(21) Appl. No.: 11/895,161

(22) Filed: Aug. 23, 2007

Related U.S. Application Data
(60) Provisional application No. 60/840,142, filed on Aug. 25, 2006.

(51) Int. Cl. G06Q 40/00

(52) U.S. Cl. 705/35

(57) ABSTRACT

A system and method for retrieving and analyzing information on investment securities from various exchanges, organizing that information, analyzing the information and making investment decisions based on this analysis is provided. The system provides for collection of short sale time and sales data from multiple, dissimilar and disparate sources having various collection schedules by multiple data collectors. It further provides a central database for storage of the collected data with multiple mathematical and algorithmic calculations applied to the data for use in analyzing and trading investment securities. The central database has a central data store module for data storage and a central configuration module for configuring the data as well as the components of the system. The system includes a display module for generating and displaying on a website, general and user specific scheduled reports from the accessed data in the central database. The system also includes a set of algorithms and formulas that comprise security trading strategies. The presentation of the data and strategies could be any time, anywhere and in any format required by the end user. The system also provides an administration module for collecting, monitoring and configuring the collected data, data collectors, central database and the reports for the end user(s).

### FIELD OF THE INVENTION

The present invention relates to a system and method for gathering information on investment securities from various exchanges, organizing that information, analyzing the information and making investment decisions based on this analysis. More particularly system and method does this for short sales.

### BACKGROUND OF THE INVENTION

For the 213 years the U.S. stock markets have been in existence, short sellers (investors that sell stock they don't own and hope to buy it back at a lower price) have been able to sell stocks short in complete secrecy. At the same time, investors who own more than 5% of a stock or have institutional reporting requirements, such as mutual funds, have been forced to disclose their long positions in stocks. This imbalance in securities laws has given short sellers an unfair trading advantage over people who buy stocks and carry long positions. It is the equivalent of one poker player having to show his cards while the other player is able to hide his cards. The advantage to the player hiding his cards is obvious.

In January 2005, the Securities and Exchange Commission passed a new rule called, Regulation SHO. Regulation SHO (SHO=Short), was designed to implement new rules and guidelines for short selling. Two important aspects of Regulation SHO were to create daily lists of stocks that had been sold short and the stock was not properly borrowed by the short sellers (this is called a “Failure to Deliver”). Secondly, the rule allowed researchers to contact U.S. stock exchanges and access the short sale time and sale information on every short sale in NYSE, AMEX and NASDAQ stocks. For the first time in history the size and price of every short sale in stocks listed on these Exchanges were being disclosed.

### SUMMARY OF THE INVENTION

The present invention aggregates all of this short sale time and sales information and applies database and mathematical algorithms to display the data in a useful format to end users. The resulting data analyzed by the system is then present in a functional format of useful information to help investor's trade stocks. The data is combined with another facet of the invention a trading strategies to help investors identify which stocks should be bought and sold and the time and price they should be bought and sold.

### BRIEF DESCRIPTION OF THE DRAWINGS

The invention will be better understood by an examination of the following description, together with the accompanying drawings, in which:

FIG. 1 shows a standard format for posting of data to an exchanges website;

FIG. 2 provides a view of the raw data posted;

FIG. 3 shows how in a preferred embodiment the data is organized in the relational database according to the present invention;

FIG. 4 shows how the data, organized according to a preferred embodiment of the present invention, might be displayed after it is down loaded and displayed on a customer's computer;

FIG. 5 provides a display that a user would enter a stock symbol, in a preferred embodiment to down load Data for a stock that has been analyzed and collated by the system of the present invention;

FIG. 6 shows a preferred embodiment of how a user might first receive the data analyzed and collated by the system of the present invention with the option of opening or saving the data first; and

FIG. 7 provides a preferred embodiment of display a user would see after requesting a list of alerts generated by the system of the present invention.

Features appearing in multiple figures with the same reference numeral are the same unless otherwise indicated.

### DETAILED DESCRIPTION OF THE PREFERRED EMBODIMENTS

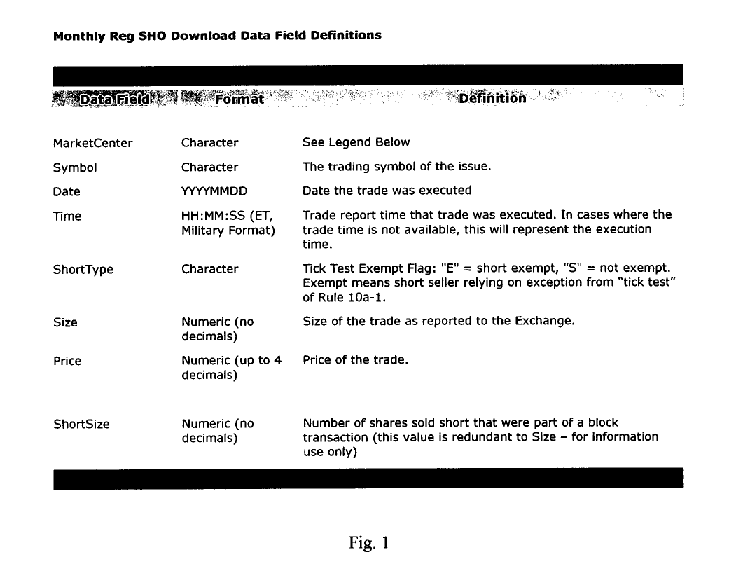

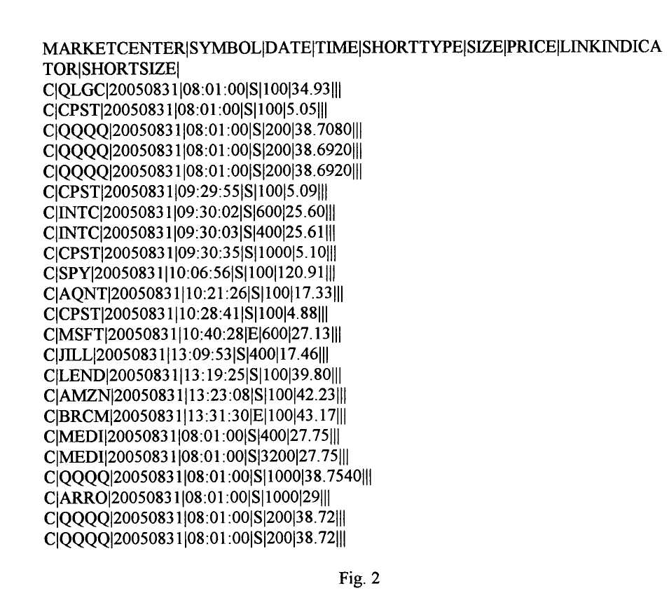

I. Retrieving, organizing, storing and displaying short sales data.
a. A method for retrieving, storing, processing and displaying short sale time and sales data provided by securities exchanges and Self Regulatory Organizations and providing related data files, stock market trading systems, strategies and formulae to users via the Internet. Each month the following securities exchanges and Self Regulatory Organizations each post a file to their respective web sites:
   A=American Stock Exchange
   ArcaEx=Archipelago Stock Exchange
   B=Boston Stock Exchange
   C=National (Cincinnati) Stock Exchange
   D=National Association of Securities Dealers (ADF)
   E=Market Independent (SIP—Generated)
   I=The Island, ECN
   M=Chicago Stock Exchange
   N=New York Stock Exchange
   P=Pacific Exchange
   T/Q=NASDAQ Stock Exchange
   S=Consolidated Tape System
   X=Philadelphia Stock Exchange
   W=CBOE
b. Each file contains short sale time and sales data that was not previously publicly available due to securities exchange and regulatory rules and standards. The data is posted to each exchange's website in the file format depicted in FIG. 1.
c. As sample of the raw data posted is shown in FIG. 2.
d. The short sale time and sales data is retrieved from each source once per month, aggregated in a relational database, sorted by stock symbol and a variety of other fields and formulas are applied to the data. The system of the present invention creates tables that show all the short sales, number of shares shorted, price of short sale, and dollar value of the short and average price per share of the short sales. The average price per share that the stock was shorted is calculated for each month separately and then combined for all months for a cumulative calculation. This is the short squeeze price or SqueezeTrigger™ price.
   A short squeeze is when an investor sells shares of stock short without owning them, borrows the shares from a third party in hopes that the stock price will drop, but results in the short seller having to pay higher and higher prices to repurchase the stock so that the investor can return the shares to the entity from which they were borrowed. Short squeezes occur when the current stock price exceeds the volume weighted average price that shares were sold short.
e. The information regarding the short sales information on each stock as follows:

Company Name (Stock Symbol)

# of Days on Naked Short Threshold List

Short Volume (number of shares)

Short Dollar Value

Average Short Price Per Share

Current Price (15 min delayed)*

Amount Above/Below Avg. Short Price

% Above/Below Avg. Short Price

Total Number of Short Trades

Total Short Interest **

Volume Weighted Average Short Price (VWASP) ***

Time Weighted Average Short Price (TWASP) ******

Shares Outstanding **

% of Shares Outstanding Shorted ****

Float (stock not owned by insiders) **

% of Float Shorted **

% Owned by Institutions **

% Owned by Insiders **

Total Change in Short Interest **

Days to Cover **

Average Daily Volume **

* Current Price provided by a market data, provider.

** Data provided by AMEX, NASDAQ and NYSE securities exchanges

***VWASP is calculated by multiply each months short volume divided by each month's avg price, add altogether and then divide by total volume used in this calculation

**** calculate this by dividing Total Short Interest for Month into Shares Outstanding

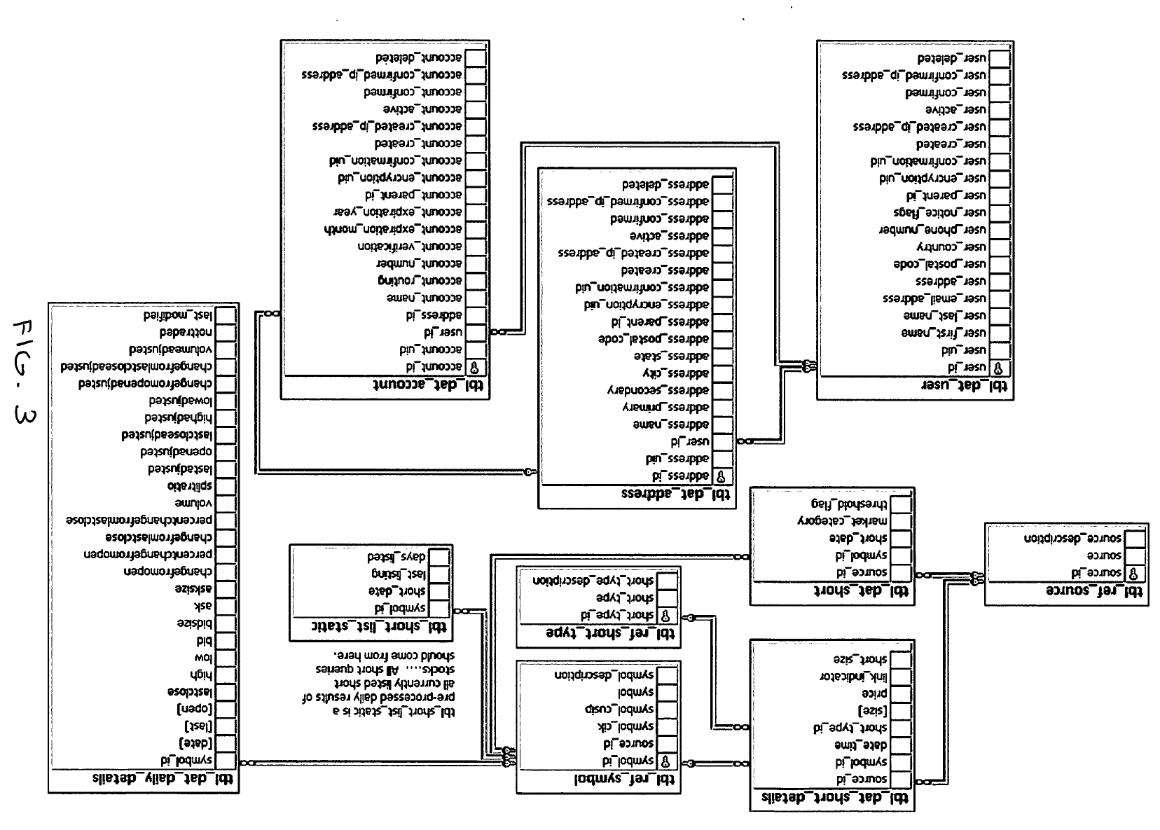

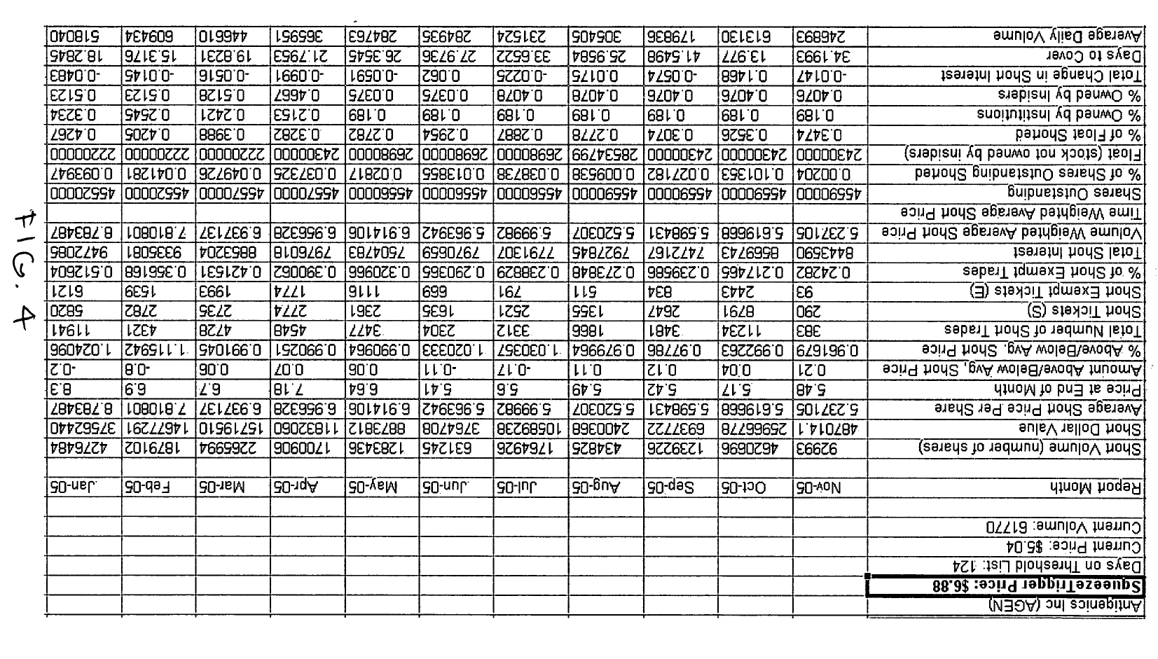

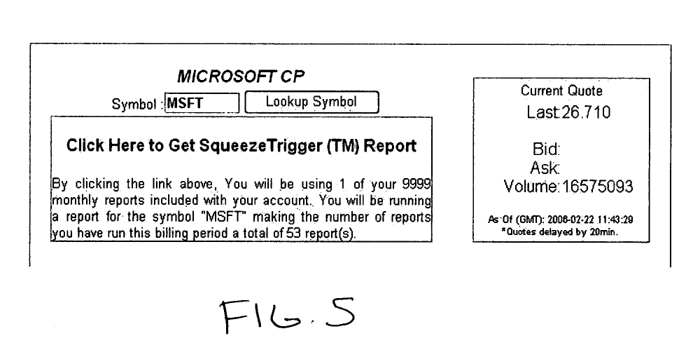

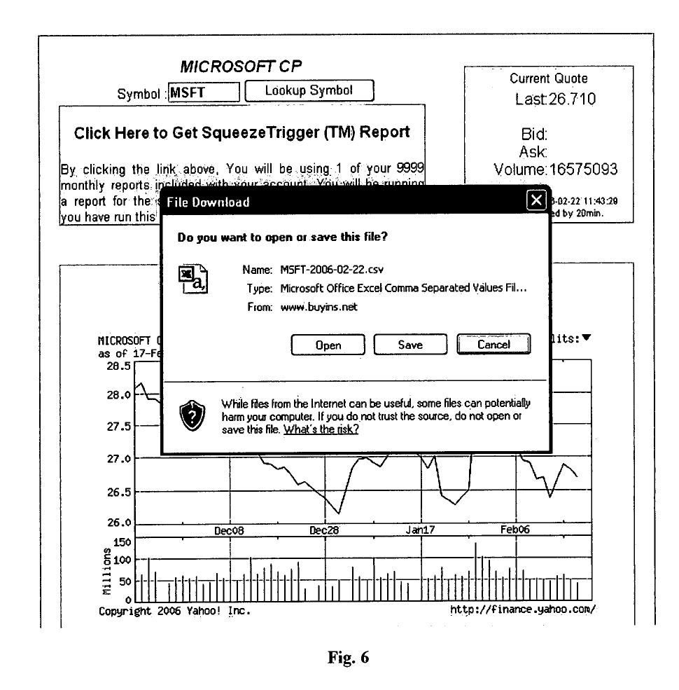

****** TWASP statistic is calculated as follows: Total Short Interest minus Most Recent Month's Short Volume plus Previous Month's Remaining Volume Average Price (all weighted) For example: TOTAL SHORT INTEREST=3 Million−2 MM shares shorted this month at AVERAGE PRICE of $10 and 1 MM remaining shares shorted the previous month at AVERAGE PRICE of $12=VWASP of $10.66
f. If short sale time and sales data is unavailable for any given stock, the short squeeze price can alternatively be approximated using the following formula: add the following values for a specific stock for each trading day: open price+hi price+low price+closing price and divide the sum by 4 (four). Multiply the resulting value X total volume for that day. Do this for each trading day for each calendar month. Add up the resulting values for all trading days in a given month and divide by the total number of shares traded in that month. The resulting value will equal the approximate short squeeze price for that specific stock for the month. This is known as the Monthly short squeeze price. The same equation can be done for multiple months and is considered the Cumulative short squeeze price.
g. Then following is another method of calculating the short squeeze price or Squeeze Trigger™ Price
   An alternative method for calculating the short squeeze price of a stock is to calculate the monthly change in Total Short Interest (provided by the stock exchanges) per stock and multiply by the Volume Weighted Average Price of all shares traded for the exact trading days represented by the Total Short Interest shares (usually from 10^{th} day of the previous month to 10^{th} day of the current month, but does vary slightly from time to time). Then add the product of (change in Total Short Interest shares multiplied by the Volume Weighted Average Price of those shares) for all months used in the calculations and divide by the number of net Total Short Interest shares used in the calculation. The formula is as follows:
      Total Short Interest February 10^{th}−Total Short Interest January 10^{th}=net change in shares of Total Short Interest.
   Calculate the Volume Weighted Average Short Price ((daily open price+daily high price+daily low price+daily close price)/4) * total daily volume. Add this resulting value for every trading day in the Total Short Interest monthly time period, ie. January 10^{th}-February 10^{th}. Divide the resulting value by the total trading volume for that month. The result is the short squeeze price for the change in Total Short Interest shares for that month.
   To calculate the Cumulative short squeeze price for all change in Total Short Interest shares for a multi month period, multiply the change in Total Short Interest shares for each month by the Volume Weighted Average Short Price for shares traded in that exact same monthly period and add the resulting values for all months in the calculation and divide by the net monthly change in Total Short Interest shares for all months in the calculation. The resulting value is the short squeeze price for all monthly net change in Total Short Interest shares for any given time period.
h. FIG. 3 shows how the data is organized in the relational database according to the present invention.
i. FIG. 4 shows how the data, organized according to a preferred embodiment of the present invention, might be displayed after it is down loaded and displayed on a customer's computer.
j. Users can request the short squeeze or SqueezeTrigger™ data files for one symbol at a time or upload a multiple symbol list to Buyins.net where short data for all the symbols uploaded are downloaded in one combined spreadsheet.
k. FIG. 5 provides a display that a user would enter a stock symbol, in a preferred embodiment to down load short squeeze Data for a stock.
l. FIG. 6 shows a preferred embodiment of how a user might first receive the short squeeze data with the option of opening or saving the data first.

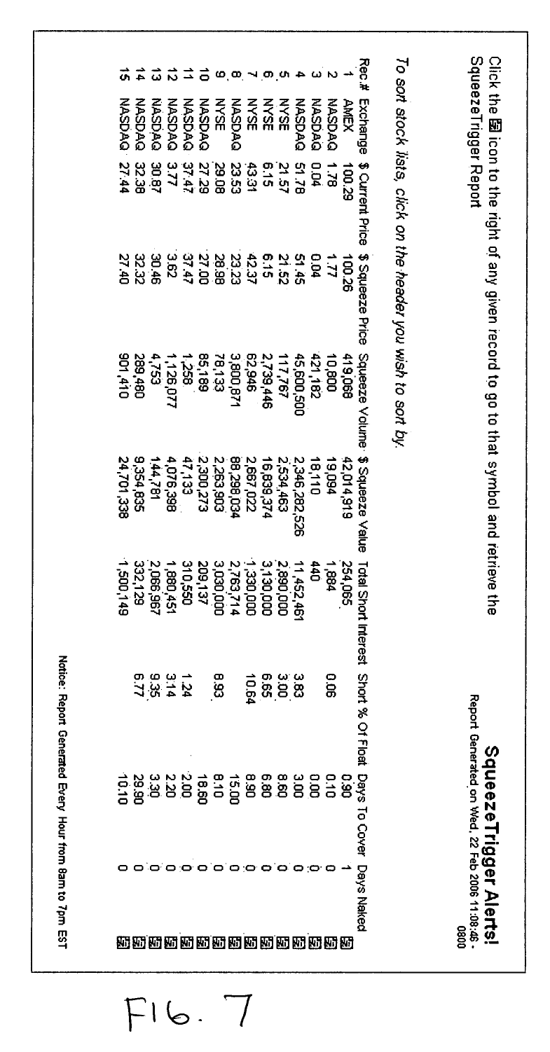

II. Manipulating the information obtained and organized in part I to provide alerts of significant events for the short sales of stocks being monitored.
a. A method for retrieving, storing, processing and displaying which of 15,000 US stocks have their stock price crossing above one or more of their monthly volume weighted average short price per share or cumulative short squeeze or SqueezeTrigger™ levels. A computer software program checks the monthly volume weighted average short price per share and cumulative volume weighted average short price per share (“SqueezeTrigger”) values for all NASDAQ, AMEX, NYSE, OTCBB and PINKSHEET stocks and compares the data to a data feed of current stock prices for all U.S. stocks. For those stocks that meet this criteria, a link is posted dynamically to the www.buyins.net web site for users to be able to click and hyperlink to a downloadable file displaying all the short sale time/sales data for that particular stock. The program continuously scans the market for these “SqueezeTrigger Crossover” events and dynamically displays the results at www.buyins.net.
b. The dynamic link for short squeeze crossovers does not immediately display which underlying stock symbol has met the short squeeze crossover criteria. Only after the user registers and/or logs in, can the user access a link that provides the stock symbol and underlying short sale time/sales data for that particular stock
c. The short squeeze or Squeeze Trigger Alert list of dynamically generated links can be sorted using the following conditions:
   Sort by Exchange (AMEX, NASDAQ, NYSE, OTCBB, PINK)
   Sort by Last Price (prices updated in real time or delayed by 15-20 minutes)
   Sort by Short Volume (shares shorted for month that price just crossed over)
   Sort by Short Dollar Value (dollar amount for month that price just crossed over)
   Sort by Total Short Interest (provided by each respective securities exchange)
   Sort by % of Float (provided by each respective securities exchange)
   Sort by Days to Cover (provided by each respective securities exchange)
   Sort by Days Listed on Naked Short List (use 0 if not on the list)
d. A short squeeze graphic is displayed to the right of every dynamic short squeeze alert link so users can click on it to get the report and find out which stock symbol it represents along with accessing the underlying detailed short sale time and sales data.
e. FIG. 7 provides a preferred embodiment of display a user would see after requesting a list of Squeeze Trigger™ alerts.

III. A system for analyzing short sales data to determine optimal sell or purchase points.
a. A method for storing, retrieving and processing short sale statistical data, algorithms and related stock trading strategies so that a person or computer can effect buy and sell decisions in equity securities.
b. A stock trading strategies that use short squeeze data to trade equities and options. The short squeeze strategies are entitled: VWASP Crossover and TWASP Crossover and are abbreviated as VWASP-X and TWASP-X respectively.
c. The Buyins.net web server sends a short squeeze of SqueezeTrigger™ data feed to a stock trading program using XML. The database feed includes these fields:
   For cumulative VWASP and TWASP data feeds:
   “Symbol”,“VWASP”,“TWASP”,“Days_listed”,“Short_interest”
   For monthly VWASP and TWASP data feeds:
   “Symbol”,“VWASP”,“TWASP”,“Days_listed”,“Short_interest”
   Definitions:
   Symbol=stock symbol
   Cumulative VWASP=volume weighted average short price. It is the average price of all short sale transactions in a stock starting January 2005 and is updated each month.
   Monthly VWASP=volume weighted average short price. It is the average price of each months' short sale transactions in a stock starting January 2005 and is updated each month.
   Cumulative TWASP=time weighted average short price. It is the average of all short sale transactions (starting January 2005 to present) accounting for the fact that people cover some or all of their shorts and is updated each month.
   Monthly TWASP=time weighted average short price. It is the average of short sale transactions per month (starting January 2005 to present) accounting for the fact that people cover some or all of their shorts and is updated each month.
   Days Listed=states whether or not a stock is Naked Short and if so, the number of days the stock has been Naked Short.
   Short Interest=most recent month's Total Short Interest for that particular stock.
d. Parameters: The strategies operate in both a real time and end of day time periods.
e. (TRADE ENTRIES) The strategies “Enter” a stock trade by signaling a buy order according to the following criteria:
   1. Buy immediately when current bar crosses above VWASP
   2. Buy immediately when current bar crosses above TWASP
   3. Buy at open tomorrow when today's closing price exceeds the VWASP.
   4. Buy at open tomorrow when today's closing price exceeds the TWASP.
   (TRADE EXITS): Sell shares of stock that have been purchased using the VWASP and TWASP Crossover strategies when any of the following conditions have been met:
   If a stock trades at under $10 per share:
   Fixed Loss Stop Exit: Sell VWASP or TWASP long position if the stock price drops more than 10% from the initial purchase price.
   Trailing Profit Stop Exit: Sell VWASP or TWASP long position if the stock trade becomes profitable and then drops more than 10% from the highest price the stock has attained after having entered the trade.
   If a stock trades at over $10 per share:
   Fixed Loss Stop Exit: Sell VWASP or TWASP long position if the stock price drops more than 5% from the initial purchase price.
   Trailing Profit Stop Exit: Sell VWASP or TWASP long position if the stock trade becomes profitable and then drops more than 5% from the highest price the stock has attained after having entered the trade.
f. Appendix A below provides a sample of a data feed for cumulative TWSP and VWSP.

### Appendix

Here are the sample datafeeds for Cumulative TWASP and VWASP:

CSV:

“symbol”,“VWASP”,“TWASP”,“days listed”,“short_interest”

“AMTC”,“234.2342”,“”,“132”,“42353534” “CALM”,“234.2342”,“”,“132”,“42353534”

“TSICQ”,“234.2342”,“”,“30”,“42353534” “FVCCQ”,“234.2342”,“”,“30”,“42353534”

“BOE”,“234.2342”,“”,“30”,“42353534” “IIJI”,“234.2342”,“”,“28”,“42353534”

“BVSN”,“234.2342”,“”,“27”,“42353534” “ICAD”,“234.2342”,“”,“27”,“42353534”

“BDCO”,“234.2342”,“”,“27”,“42353534” “GMK”,“234.2342”,“”,“26”,“42353534”

PIPE:

symbol|VWASP|TWASP|days_listed|short_interest AMTC|1234.2342∥132|42353534

CALM234.2342∥132|42353534 TSICQ|234.2342∥30|42353534

FVCCQ|234.2342∥30|42353534 BOE1234.2342∥30|42353534 IIJI|234.2342∥28|42353534

BVSN|234.2342∥27|42353534 ICAD|1234.2342∥27|42353534

BDCO|234.2342∥27|42353534 GMK|234.2342∥26|42353534

RSS (XML)

```
  <?xml version=“1.0” encoding=“iso-8859-1” ?>
- <rss version=“2.0”>
- <channel>
  <title />
  <link>http://www.buyins.net/</link>
  <description />
  <language>en-us</language>
  <copyright />
  <managingEditor />
  <webMaster />
  <generator />
  <docs>http://www.buyins.net/</docs>
  <pubDate>2005-07-21 07:50:18</pubDate>
  <lastBuildDate />
  <data />
- <item>
  <title>AMTC</title>
  <description>Ameritrans Capital Corp</description>
  <link>http://www.buyins.net/tools/symbol_stats.php?sym=AMTC
  </link>
- <content>
  <symbol>AMTC</symbol>
  <VWASP>234.2342</VWASP>
  <TWASP />
  <days_listed>132</days_listed>
  <short_interest>42353534</short_interest>
    </content>
    </item>
- <item>
  <title>CALM</title>
  <description>CAL MAINE FOODS INC</description>
  <link>http://www.buyins.net/tools/symbol_stats.php?sym=CALM
  </link>
- <content>
  <symbol>CALM</symbol>
  <VWASP>234.2342</VWASP>
  <TWASP />
  <days_listed>132</days_listed>
  <short_interest>42353534</short_interest>
    </content>
    </item>
- <item>
  <title>TSICQ</title>
  <description>TROPICAL SPORTSWE</description>
  <link>http://www.buyins.net/tools/symbol_stats.php?sym=TSICQ
  </link>
- <content>
  <symbol>TSICQ</symbol>
  <VWASP>234.2342</VWASP>
  <TWASP />
  <days_listed>30</days_listed>
  <short_interest>42353534</short_interest>
    </content>
    </item>
- <item>
  <title>FVCCQ</title>
  <description />
  <link>http://www.buyins.net/tools/symbol_stats.php?sym=FVCCQ
  </link>
- <content>
  <symbol>FVCCQ</symbol>
  <VWASP>234.2342</VWASP>
  <TWASP />
  <days_listed>30</days_listed>
  <short_interest>42353534</short_interest>
    </content>
    </item>
- <item>
  <title>BOE</title>
  <description>BLACKRCK GL OP EQ</description>
  <link>http://www.buyins.net/tools/symbol_stats.php?sym=BOE</link>
- <content>
  <symbol>BOE</symbol>
  <VWASP>234.2342</VWASP>
  <TWASP />
  <days_listed>30</days_listed>
  <short_interest>42353534</short_interest>
    </content>
    </item>
- <item>
  <title>IIJI</title>
  <description>INTERNET INIT JAP</description>
  <link>http://www.buyins.net/tools/symbol_stats.php?sym=IIJI</link>
- <content>
  <symbol>IIJI</symbol>
  <VWASP>234.2342</VWASP>
  <TWASP />
  <days_listed>28</days_listed>
  <short_interest>42353534</short_interest>
    </content>
    </item>
- <item>
  <title>BVSN</title>
  <description>Broadvision Inc</description>
  <link>http://www.buyins.net/tools/symbol_stats.php?sym=BVSN
  </link>
- <content>
  <symbol>BVSN</symbol>
  <VWASP>234.2342</VWASP>
  <TWASP />
  <days_listed>27</days_listed>
  <short_interest>42353534</short_interest>
    </content>
    </item>
- <item>
  <title>ICAD</title>
  <description>icad Inc</description>
  <link>http://www.buyins.net/tools/symbol_stats.php?sym=ICAD
  </link>
- <content>
  <symbol>ICAD</symbol>
  <VWASP>234.2342</VWASP>
  <TWASP />
  <days_listed>27</days_listed>
  <short_interest>42353534</short_interest>
    </content>
    </item>
- <item>
  <title>BDCO</title>
  <description>Blue Dolphin Energy Co</description>
  <link>http://www.buyins.net/tools/symbol_stats.php?sym=BDCO
  </link>
- <content>
  <symbol>BDCO</symbol>
  <VWASP>234.2342</VWASP>
  <TWASP />
  <days_listed>27</days_listed>
  <short_interest>42353534</short_interest>
    </content>
    </item>
- <item>
  <title>GMK</title>
  <description>GRUMA SA DE CV AD</description>
  <link>http://www.buyins.net/tools/symbol_stats.php?sym=GMK</link>
- <content>
  <symbol>GMK</symbol>
  <VWASP>234.2342</VWASP>
  <TWASP />
  <days_listed>26</days_listed>
  <short_interest>42353534</short_interest>
    </content>
    </item>
    </channel>
    </rss>
```

Here is a sample datafeed for the Monthly VWASP and TWASP:

```
  <?xml version=“1.0” encoding=“iso-8859-1” ?>
- <rss version=“2.0”>
- <channel>
  <title />
  <link>http://www.buyins.net/</link>
  <description />
  <language>en-us</language>
  <copyright />
  <managingEditor />
  <webMaster />
  <generator />
  <docs>http://www.buyins.net </docs>
  <pubDate>2006-02-22 16:38:14</pubDate>
  <lastBuildDate />
- <meta>
  <items>1</items>
- <header>
  <symbol>varchar(7)</symbol>
- <VWASP>
  <size>int</size>
  <value>decimal(18,3)</value>
  <date>datetime()</date>
    </VWASP>
- <TWASP>
  <size>int</size>
  <value>decimal(18,3)</value>
  <date>datetime()</date>
    </TWASP>
  <days_listed>int</days_listed>
  <short_interest>int</short_interest>
    </header>
    </meta>
- <item>
  <title>IBM</title>
  <description>INTL BUSINESS MAC</description>
  <link>http://www.buyins.net/tools/symbol_stats.php?sym=IBM</link>
- <content>
  <symbol>IBM</symbol>
- <VWASP>
  <size>22100</size>
  <value>81.174</value>
  <date>2006-01-01 00:00:00</date>
    </VWASP>
- <VWASP>
  <size>3759386</size>
  <value>85.053</value>
  <date>2005-12-01 00:00:00</date>
    </VWASP>
- <VWASP>
  <size>39473227</size>
  <value>86.045</value>
  <date>2005-11-01 00:00:00</date>
    </VWASP>
- <VWASP>
  <size>6989355</size>
  <value>82.332</value>
  <date>2005-10-01 00:00:00</date>
    </VWASP>
- <VWASP>
  <size>34102778</size>
  <value>79.744</value>
  <date>2005-09-01 00:00:00</date>
    </VWASP>
- <VWASP>
  <size>30762557</size>
  <value>82.220</value>
  <date>2005-08-01 00:00:00</date>
    </VWASP>
- <VWASP>
  <size>56394049</size>
  <value>81.024</value>
  <date>2005-07-01 00:00:00</date>
    </VWASP>
- <VWASP>
  <size>40475501</size>
  <value>75.892</value>
  <date>2005-06-01 00:00:00</date>
    </VWASP>
- <VWASP>
  <size>43289642</size>
  <value>75.617</value>
  <date>2005-05-01 00:00:00</date>
    </VWASP>
- <VWASP>
  <size>61207062</size>
  <value>79.324</value>
  <date>2005-04-01 00:00:00</date>
    </VWASP>
- <VWASP>
  <size>35480878</size>
  <value>91.116</value>
  <date>2005-03-01 00:00:00</date>
    </VWASP>
- <VWASP>
  <size>18642342</size>
  <value>93.558</value>
  <date>2005-02-01 00:00:00</date>
    </VWASP>
  <TWASP />
  <days_listed />
  <short_interest />
    </content>
  <pubDate>2006-01-01 00:00:00</pubDate>
    </item>
    </channel>
    </rss>
```

What is claimed is:

1. A method for collecting data for analysis from multiple data sources, comprising: receiving data from the multiple data sources in accordance with an automated data retrieval schedule; wherein multiple data collectors retrieve data from multiple stock exchange data sources, multiple real time stock price data sources and multiple legacy system data sources; wherein the stock exchange data sources provide short sale time and sales data for all short sale transactions in equity securities, real time stock price data sources provide stock price quote related information for stocks that have short sales, and legacy data sources provide results of mathematical calculations performed on multiple data sources in a proprietary format; and the data retrieval schedule is set up by an automated time-based scheduler; parsing the data collected from the multiple data sources, wherein a parsing module parses the collected data; wherein a processor parses the data; evaluating short sale trading conditions based on data collection; evaluating web site display conditions at time of data collection, wherein display and threshold conditions are set up to evaluate pre-defined conditions of incoming data and data that is displayed to a user.

2. A system for collecting data for analysis from multiple data sources, comprising: receiving data from the multiple data sources in accordance with an automated data retrieval schedule; wherein multiple data collectors retrieve data from multiple stock exchange data sources, multiple real time stock price data sources and multiple legacy system data sources; wherein the stock exchange data sources provide short sale time and sales data for equity securities, real time stock price data sources provide stock price quote related information for stocks that have short sales, and legacy data sources provide results of mathematical calculations performed on multiple data sources in a proprietary format; and the data retrieval schedule is set up by an automated time-based scheduler; parsing the data collected from the multiple data sources, wherein a parsing module parses the collected data; wherein a processor parses the data; evaluating short sales on all securities based on data collection; evaluating web site display conditions at time of data collection, wherein display and threshold conditions are set up to evaluate pre-defined conditions of incoming data and data that is displayed to a user.

3. Computer-executable process steps in computer readable memory, for collecting data for analysis from multiple data sources, comprising: receiving data from the multiple data sources in accordance with an automated data retrieval schedule; wherein multiple data collectors retrieve data from multiple stock exchange data sources, multiple real time stock price data sources and multiple legacy system data sources; wherein the stock exchange data sources provide short sale time and sales data for all publicly traded equities, real time stock price data sources provide stock price quote related information for stocks that have short sales, and legacy data sources provide results of mathematical calculations performed on multiple data sources in a proprietary format; and the data retrieval schedule is set up by an automated time-based scheduler; parsing the data collected from the multiple data sources, wherein a parsing module parses the collected data; wherein a processor parses the data; evaluating threshold conditions based on data collection; evaluating web site display conditions at time of data collection, wherein display and short sale conditions are set up to evaluate pre-defined conditions of incoming data and data that is displayed to a user.

4. A computer-implemented method executed on a computer of trading a position in a security which has a value and which is actually being traded, comprising the steps of: (A) determining the Monthly or Cumulative SqueezeTrigger Price of a security (B) determining the current price for the security at a first point in time; (C) outputting instructions to purchase an ownership position in the security when said actual value of the security reaches or passes said SqueezeTrigger price trading strategy conditions (D) monitoring the actual value of the security over a period of time; (E) outputting instructions to sell position in the security, being performed by said computer and based on price, percentage, volume or time conditions, and without human intervention, after the performance of step (C).

5. A computer program product for use with a graphics display device, said computer program product comprising a computer usable medium having computer readable program code executed on a computer for (A) determining the Monthly or Cumulative SqueezeTrigger Price of a security (B) determining a current price for the security at a first point in time; (C) outputting instructions to purchase ownership position in the security when said actual value of the security reaches or passes said SqueezeTrigger price trading strategy conditions (D) monitoring the actual value of the security over a period of time; (E) outputting instructions to sell position in the security, being performed by said computer and based on price, percentage, volume or time conditions, and without human intervention, after the performance of step (C).
